(19) United States
(12) Patent Application Publication
(10) Pub. No.: US 2014/0053020 A1
(43) Pub. Date: Feb. 20, 2014

(54) SYSTEM FOR AND METHOD OF IMPROVING TRANSACTION PROCESSING AND FLOW-THROUGH

(71) Applicants: Dhanrai J. NAIR, Flower Mound, TX (US); Mirela E. COSUTA, Trophy Club, TX (US); Priya HARIHARAN, Coppell, TX (US); Narayanasamy RENGASAMY, Flower Mound, TX (US)

(72) Inventors: Dhanrai J. NAIR, Flower Mound, TX (US); Mirela E. COSUTA, Trophy Club, TX (US); Priya HARIHARAN, Coppell, TX (US); Narayanasamy RENGASAMY, Flower Mound, TX (US)

(73) Assignee: VERIZON PATENT AND LICENSING, INC., Basking Ridge, NJ (US)

(21) Appl. No.: 13/589,716

(22) Filed: Aug. 20, 2012

(51) Int. Cl. G06F 11/16

(52) U.S. Cl. 714/15; 714/E11.054

(57) ABSTRACT

A system for and method improving order and transaction flow-though and processing. The method may include receiving an order request from a user corresponding to the order. The method may further include determining a set of order particulars associated with the user and the order for resolution against an external system for order fulfillment, and determining if any order particular is incorrect or missing. The method may also include identifying the missing or correct order particular, and updating the set of order particulars to include the missing or correct order particular without requesting missing or correct order particular from the user. The method may include transmitting the updated order particulars to the external system for order fulfillment.

### BACKGROUND INFORMATION

Transactions are increasingly being carried out using a number of channels and portals, such as computer terminals, mobile devices, the Internet, and customer service representatives or call centers. The ever-increasing volume has put pressure on back-end processing system to ensure seamless flow-through and resolution. Every transaction has associated with it information that is required to process and resolve the transaction. For example, if an individual is purchasing a product through a web site, sufficient data must be provided to ensure the desired product is identified, the proper amount is charged to the individual's credit card or account, and the product is delivered to correct address. If essential information is incorrect or omitted (e.g., the zip code of the shipping address or the expiration of the credit card), the transaction may not be carried out or resolved. Currently, such errors are corrected by requiring the customer or call center representative to provide the missing information. This is time-consuming and can lead to other inefficiencies.

### BRIEF DESCRIPTION OF THE DRAWINGS

The present invention, together with further objects and advantages, may best be understood by reference to the following description taken in conjunction with the accompanying drawings, in the several figures of which like reference numerals identify like elements, and in which:

FIG. 1 is a schematic diagram illustrating a system for processing orders and transactions according to a particular embodiment;

FIG. 2 is a block diagram illustrating a system for processing orders and transactions according to a particular embodiment;

FIG. 3 is a block diagram illustrating a system for processing orders and transactions according to a particular embodiment;

FIG. 3a is a chart illustrating various data and information associated with a rejection or error code according to a particular embodiment;

FIG. 4 is a flowchart illustrating the functionality and architecture of a system for processing orders and transactions according to a particular embodiment; and

FIG. 5 is a flowchart illustrating the functionality of a system for processing orders and transactions according to a particular embodiment.

### DETAILED DESCRIPTION OF PREFERRED EMBODIMENTS

An exemplary embodiment provides a system and method for processing orders and transactions, and in particular a system and method that improves flow-through processing of such orders and transactions. In an embodiment, a service provider may receive order and transaction requests from any of a number of sources, including but not limited to, customers and customer service representatives. Order and transaction requests may be initiated via any number of devices and platforms, such as a computer terminal, mobile device or a call center, for example. In some embodiments, orders and transactions requests may be received and processed by an order and transaction processing system that makes the appropriate determinations to resolve the request, including interacting with any necessary external systems and platforms. The order and transaction processing system may also correct order and transaction requests that are rejected by the external systems to missing or incorrect data, and resubmit the corrected requests for resolution. For example, the order and transaction processing system may receive rejections from external systems and determine, based on the rejection code, whether the order may be corrected. If so, the order may be placed in a retry queue from where it will be processed to correct the incorrect or missing information.

The systems and methods described herein may dynamically correct rejected orders and resubmit them for resolution and fulfillment. For example, a customer ordering a particular product or service via a web site may inadvertently fail to provide his or her user name or user identification. In such a situation, the systems and methods disclosed herein may nonetheless seek to resolve the request by determining the user's name or identification given information provided by the customer or otherwise known, such as for example, the customer's address, phone number, account number, or any other information that may be used to identify the customer. The known information may be provided or resolved against a database or other device that determines the user's name or identification. In so doing, the systems and methods described herein may process and resolve order and transaction requests efficiently without interrupting or otherwise involving the customer.

Similarly, the systems and methods described herein may also correct information provided by a customer and convert it to a format that is compatible with the various systems that are involved in the order and transaction fulfillment and validation process. For example, a customer initiating an order via a web site might provide a home address and in so doing spell out the complete name of the state in which he or she lives. The system that will ultimately validate and resolve the user's order, however, may only recognize certain state abbreviations and may not recognize complete name of the state. In this situation, the systems and methods described herein may determine the corresponding abbreviation without involving the user slowing down order flow-through and fulfillment. Other scenarios and situations are of course possible.

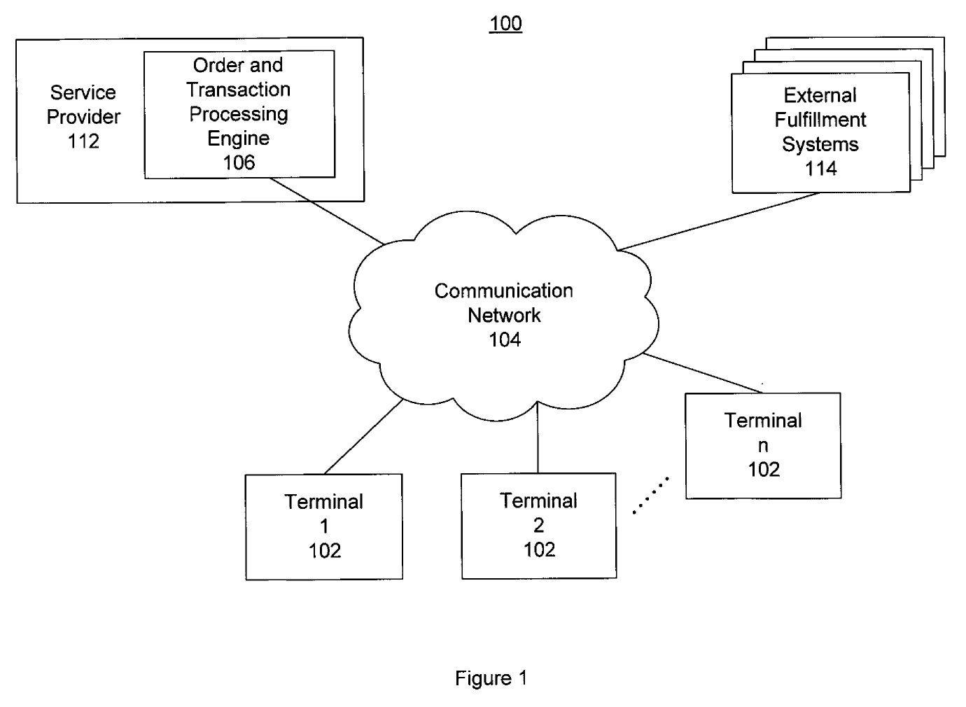

FIG. 1 is a schematic diagram illustrating a system for process orders and transactions according to a particular embodiment. As illustrated in FIG. 1, the system 100 for processing orders and transactions may include a plurality of user terminals 102(1-N) coupled to an order and transaction processing system 106 via a communication network 104. Also depicted are a plurality of external fulfillment systems 114 that may be called upon to process and resolve such orders and transactions.

As shown, the order and transaction processing system 106 may be associated with a service provider 112 that may receive and process order or transaction requests from the plurality of user devices 102(1-N). For example, the plurality of user devices 102(1-N) may transmit order or transaction requests to the order and transaction processing system 106 of service provider 112 via the communication network 104. In an exemplary embodiment, the order and transaction processing system 106 may communicate with external systems 114 to process and resolve the order and transaction requests. In some embodiments, the external systems 114 may comprise any system or platform which serve a particular function that is required to properly process and resolve an order or transaction request. Examples include, but are not limited to, billing systems, provision systems, pricing or discounts systems, or inventory control systems.

The plurality of user devices 102(1-N) may be a mobile user device, a computer, a personal computer, a laptop, a cellular communication device, a workstation, a mobile device, a phone, a television, a handheld PC, a personal digital assistant (PDA), a thin system, a fat system, a network appliance, an Internet browser, or other any other device that may be in communication with the order and transaction processing system 106 via the communication network 104. Other user devices 102(1-N) may be one or more intermediary devices that may communicate with the communication network 104, such as a transmitter/receiver, router, modem, or a set-top box. The plurality of user devices 102(1-N) may be coupled to the order and transaction processing system 106 via a wired link. In another exemplary embodiment, the plurality of user devices 102(1-N) may be coupled to the order and transaction processing system 106 via a wireless link.

User devices 102(1-N) may be accessed a customer of service provider 112 who is ordering a new service or good or is otherwise making a request. Similarly, user devices 102(1-N) may be accessed by a customer service agent of service provider 112 that is fielding a request from a customer or is otherwise initiating a request for servicing that needs to be processed by order and transaction processing system 106. In submitting requests for processing, users of user devices 102(1-N) may need to provide specific data and information that is necessary to properly process and resolve the request. In some embodiments, such information is provided directly by the customer or customer agent, or may also be provided by order and transaction processing system 106 of the service provider 112.

The communication network 104 may couple the plurality of user devices 102(1-N) to the order and transaction processing system 106. The communication network 104 may be a wireless network, a wired network or any combination of wireless network and wired network. For example, the communication network 104 may include one or more of a fiber optics network, a passive optical network, a cable network, an Internet network, a satellite network (e.g., operating in Band C, Band Ku or Band Ka), a wireless LAN, a Global System for Mobile Communication (GSM), a Personal Communication Service (PCS), a long term evolution (LTE), a Personal Area Network (PAN), D-AMPS, Wi-Fi, Fixed Wireless Data, IEEE 802.11a, 802.11b, 802.15.1, 802.11n and 802.11g or any other wired or wireless network for transmitting and receiving a data signal. In addition, the communication network 104 may include, without limitation, telephone line, fiber optics, IEEE Ethernet 802.3, wide area network (WAN), local area network (LAN), or global network such as the Internet. The communication network 104 may support an Internet network, a wireless communication network, a cellular network, or the like, or any combination thereof.

The communication network 104 may further include one, or any number of the exemplary types of networks mentioned above operating as a stand-alone network or in cooperation with each other. Although the communication network 104 is depicted as one network, it should be appreciated that according to one or more embodiments, the communication network 104 may comprise a plurality of interconnected networks, such as, for example, a service provider network, the Internet, a broadcaster's network, a cable television network, corporate networks, and home networks.

The order and transaction processing system 106 may include one or more servers. For example, the order and transaction processing system 106 may include a UNIX based server, Windows 2000 Server, Microsoft IIS server, Apache HTTP server, API server, Java sever, Java Servlet API server, ASP server, PHA server, HTTP server, Mac OS X server, Oracle server, IP server, or other independent server to support operations of a client. Also, the order and transaction processing system 106 may include one or more Internet Protocol (IP) network server or public switch telephone network (PSTN) server. The order and transaction processing system 106 may include one or more databases for storing a network model topology and network policies based at least in part on the network model topology.

The service provider 112 may include one or more servers to provide service to the plurality of user devices 102(1-N) via the communication network 104. For example, the service provider 112 may include a UNIX based server, Windows 2000 Server, Microsoft IIS server, Apache HTTP server, API server, Java sever, Java Servlet API server, ASP server, PHP server, HTTP server, Mac OS X server, Oracle server, IP server, or other independent server to provide one or more contents to the plurality of user devices 102(1-N). Also, the service provider 112 may include one or more Internet Protocol (IP) network server or public switch telephone network (PSTN) server.

The service provider 112 may include one or more storage devices including, without limitation, paper card storage, punched card, tape storage, paper tape, magnetic tape, disk storage, gramophone record, floppy disk, hard disk, ZIP disk, holographic, molecular memory. The one or more storage devices may also include, without limitation, optical disc, CD-ROM, CD-R, CD-RW, DVD, DVD-R, DVD-RW, DVD+R, DVD+RW, DVD-RAM, Blu-ray, Minidisc, HVD and Phase-change Dual storage device. The one or more storage devices may further include, without limitation, magnetic bubble memory, magnetic drum, core memory, core rope memory, thin film memory, twistor memory, flash memory, memory card, semiconductor memory, solid state semiconductor memory or any other like mobile storage devices.

The service provider 112 may include one or more servers that provide various services to user devices 102(1-N). The service providers may include, but not limited to, a radio company, a fiber optics company, a cable company (e.g., Cox Communication, Comcast Corp, and/or Adelphia Communication Corp), a satellite company (e.g., DirecTV andor Dish Network), a broadcasting company (e.g., National Broadcasting Company (NBC), American Broadcasting Company (ABC), Fox Broadcasting Company (FOX), and/or Columbia Broadcasting System (CBS)) and/or other radio/television broadcasting companies. The service provider 112 may also include, but not limited to, an Internet content providers, telephone service provider, television service provider, and/or other content service providers.

External systems 114 may include any system or platform that is necessary to properly resolve an order or transaction request. Examples include, but are not limited to, systems for the provisioning of goods or services, billing, discount submissions and equipment returning or inventory control, for example. In some embodiments, external systems 114 may receive order and transaction requests from the order and processing system 106 and perform specific or dedicated functions that are required to resolve the request. Upon performing such functions, external systems 114 may respond with a confirmation signal back to the order and transaction processing system 106. In some embodiments, external systems 114 may also reject incoming requests and respond in kind to the order and transaction processing system 106. For example, an external system may return the request along with an indication that the request could not be processed because it contained inaccurate or was missing essential data. In some embodiments, such indications may be made using designated codes that inform service provider 112 of the precise error or fault. The codes may correspond uniquely to specific problems associated with the request and may also be associated with designated rules for correcting the problem with the request. The rules may dictate specific processing that may be necessary to correct the order.

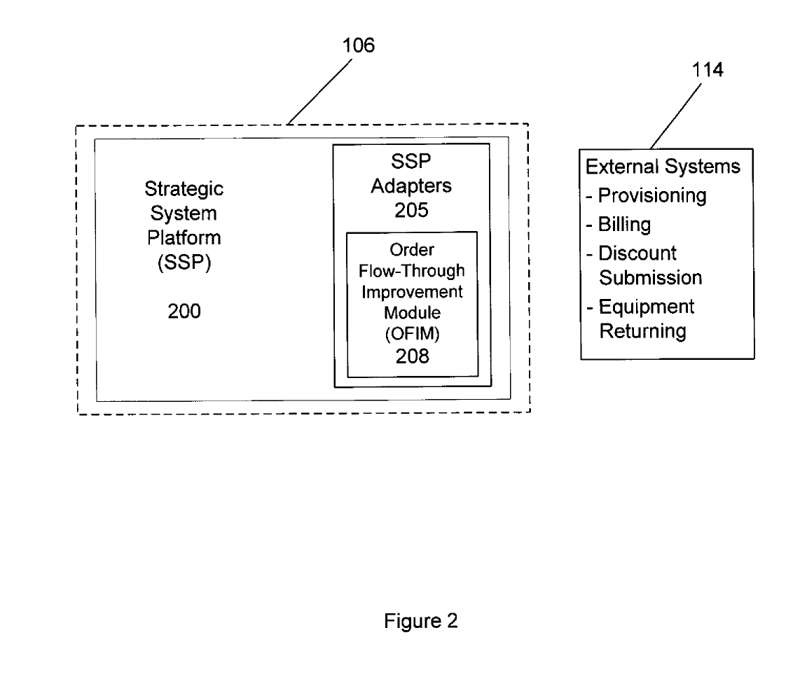

FIG. 2 is a block diagram of hardware elements of the order and transaction processing system 106 of a particular embodiment. The order and transaction processing system 106 may include a strategic system platform (SSP) 200, an SSP adapters processor 205, and an order flow-through improvement (OFIM) processor 208. It is noted that the modules 200, 205, and 218 are exemplary and the functions performed by one or more of the modules may be combined with that performed by other modules. The functions described herein as being performed by the modules 200, 205 and 208 also may be separated and may be located or performed by other modules. Moreover, the modules 200, 205 and 208, may be implemented at other devices of the system 100 (e.g., the plurality of user devices 102(1-N), the communication network 104, or the external systems 114).

SSP 200 may comprise at least one computer processor for providing an interface between the order and transaction processing system 106 and external systems 114 for order and transaction processing. The SSP 200 may include a user interface, e.g., a graphical user interface, to receive one or more requests from users of terminals 102(1-N) to initiate an order or transaction. SSP 200 may also receive requests from a customer service agent or representative, for example, that initiates orders or transactions. Similarly, customers of service provider 112 may initiate requests via the Internet, mobile device or any other terminal that permits interaction with order and transaction processing system 106. In some embodiments, queries and requests may comprise data and information initiating an order or other transaction for processing and resolution by any of external systems 114. Such orders and transactions may correspond, for example, to the provisioning of goods or services, billing, discount submissions and equipment returning.

In response to receiving requests or queries from users of terminals 110(1-N), the SSP 200 may provide the request or queries to the SSP adapters processor 205. SSP adapters processor 205 may facilitate the communication between the SSP and the different external systems 114. In some embodiments, SSP adapter processor 205 may comprise specific adapters that function to communicate with the various external systems 114 using channels of communication such as MQ, web service and file transfer mode, for example. In some embodiments, each adapter may also implement specific logic and algorithms that are unique to the external systems with which it is associated. SSP adapters processor 205 may therefore identify the appropriate adapter to engage and communicate with the necessary external system(s). In some embodiments, the appropriate adapter is identified based on particulars of the request or query. That is, the external system(s) that are necessary to fulfill the request or query will determine which adapters will need to be invoked.

Order flow-through improvement (OFIM) module 208 may, in some embodiments, correct orders that are being rejected (e.g., by external systems 114) either due to missing mandatory data or incorrect data. Specifically, OFIM module 208 may received rejected requests and indentify that reason(s) for the rejection and determine a corrective course of action to provide the missing or correct information and submit the resubmit the request to the appropriate external system for processing and resolution. In an exemplary embodiment, OFIM module 208 identifies the reason for the rejection based on particular codes that have been added by the external system. Such codes may permit the OFIM module to identify the missing or incorrect information, but also to determine where the missing or correct data can be located. In addition, the OFIM 208 corrects the defects without having to engage or receive additional information from the initiator of the request, such as a customer or call center agent of service provider 112.

For example, when an adapter submits an order to the appropriate external system, the adapter may receive either a synchronous response (e.g., an immediate or real-time response) or asynchronous response (e.g., some time later—an hour, day or week later) back from the external system(s). Such response may indicate that the request was successfully processed or that the request was rejected. In some embodiments, a rejection occurs when a request fails to meet certain criteria or if information sent to the external system is incorrect, was missing, or otherwise does not match up with what the external system needs to properly process and resolve the request. In some embodiments, the OFIM can correct the request based on the rejection by making a look up call, for example, to a database or other storage source that contains the needed data or information.

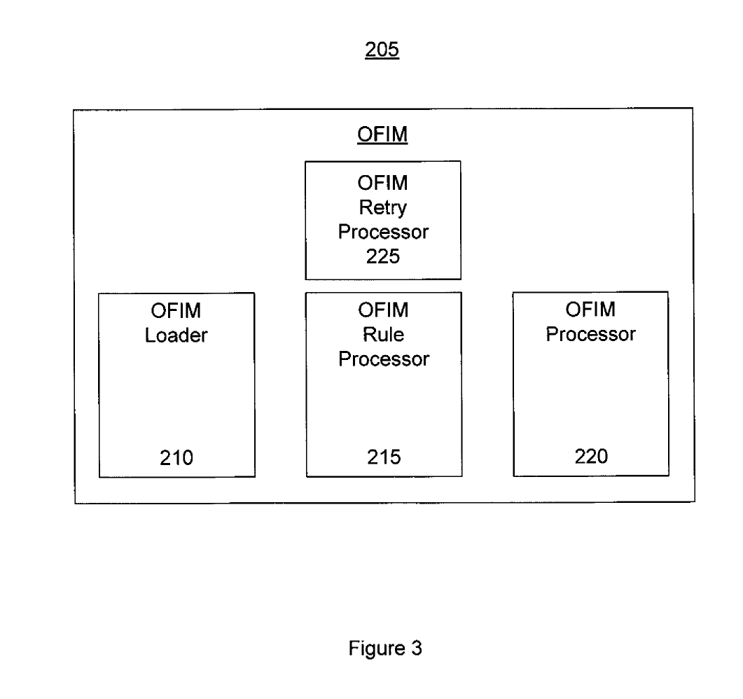

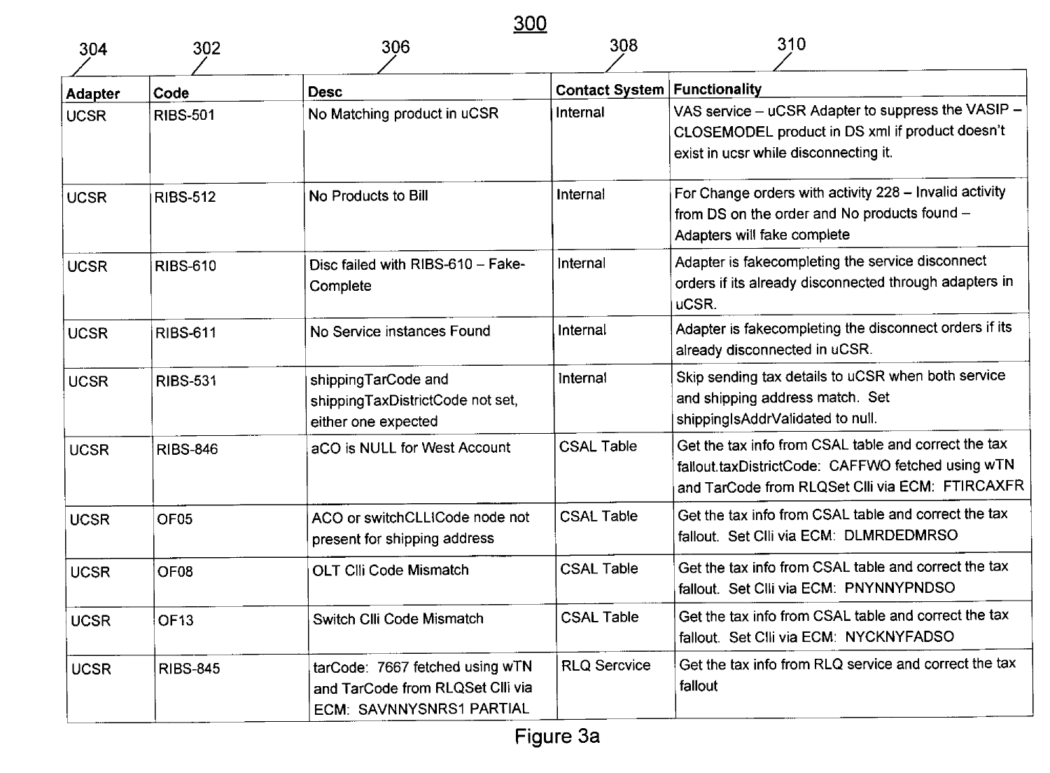

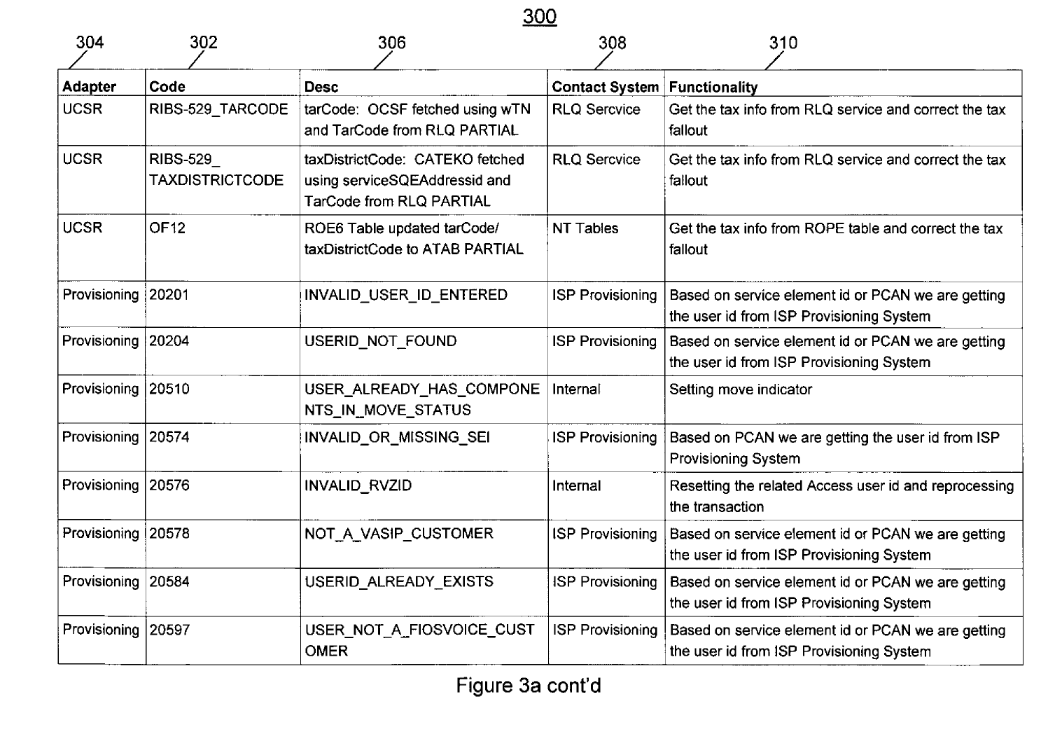

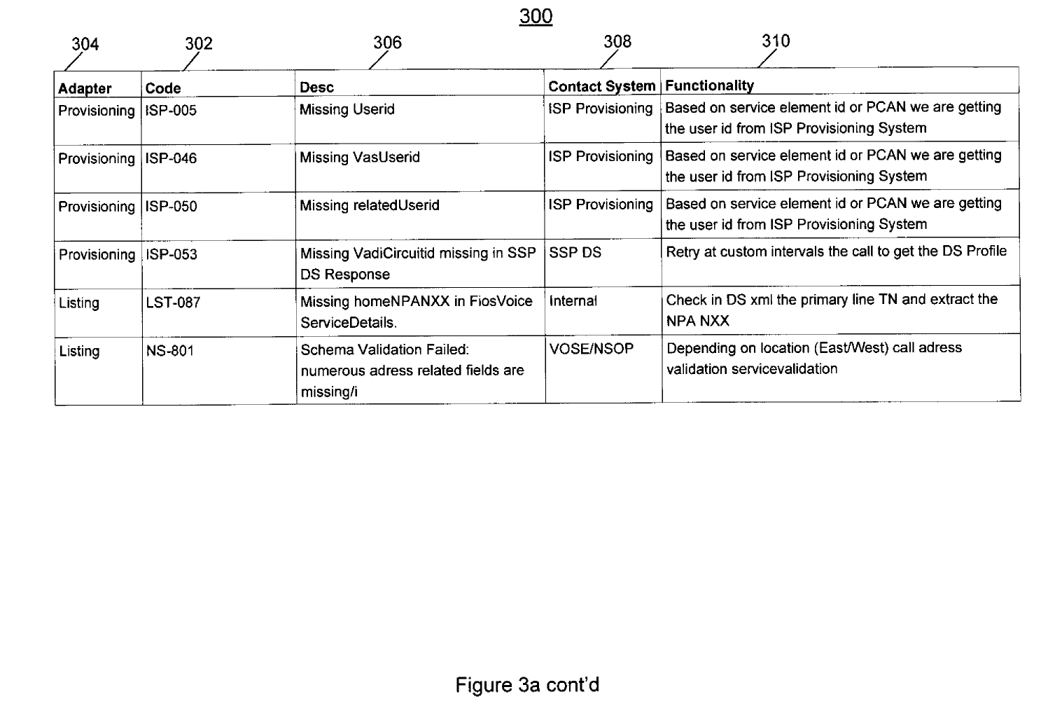

FIG. 3 is a block diagram of hardware elements of the OFIM 208 of a particular embodiment. OFIM 208 may include an OFIM loader 210, an OFIM rule processor 215, an OFIM processor 220, and an OFIM retry processor 225. It is noted that the modules 210, 215, 220 and 225 are exemplary and the functions performed by one or more of the modules may be combined with that performed by other modules. The functions described herein as being performed by the modules 210, 215, 220 and 225 also may be separated and may be located or performed by other modules. Moreover, the modules 210, 215, 220 and 225, may be implemented at other devices of the system 100 (e.g., the plurality of user devices 102(1-N), the communication network 104, or the external systems 114).

OFIM loader 210 may be invoked, in some embodiments, to load the necessary algorithms and data that are specific to the adapter corresponding to the necessary external systems. Such algorithms and data may be loaded dynamically at run time or when the SSP adapter 205 receives a request destined for a particular external system 114. In a preferred embodiment, the OFIM loader may load the algorithms and data at start-up and dynamically instantiate them and the corresponding object onto an OFIM cache with other requests to be processed. Alternatively, the algorithms and data may be pre-loaded rather than loaded at start-up. In some embodiments, the algorithms and data may comprise rules that may be unique to the particular request or order being processed.

In a preferred embodiment, every adapter associated with an OHM module 208 may include a communication module that communicates with the external systems. The OFIM module 208 may also include a response processor that processes the response received from the external systems and verifies the status. If the status is error (or rejection), the OFIM rule module 215 may be invoked. In exemplary embodiments, OFIM rule module 215 may take the adapter name and the code received from the external systems and identify all the various error codes, or OFIM codes, that are configured for the particular adapter. If the error code received from the external system matches one of the codes configured for the adapter, the rejected request will be marked for automatic error correct. In some embodiments, this is accomplished by turning on an error flag in a transaction detail object associated with rejected request which is then placed in a retry queue as an event where it will be processed by an OFIM retry processor 225.

OFIM retry processor 225 may, in some embodiments, process rejected requests (or events) that are placed in the retry queue. In exemplary embodiments, the retry processor may check for the presence of an error flag in the event. If the flag is turned off, the event object may be handled as a regular retry event without error correct and may be resubmitted to the external system for processing. However, if the flag is on, the event may be handled for error correction. The OFIM retry processor may then update the event as an OFIM event and invoke the OFIM processor from the OFIM cache based on the adapter name and delegate the OFIM event to the OFIM processor.

Upon taking over the OFIM event, OFIM processor 220 may, in exemplary embodiments, identify the error correction process based on the OFIM code associated with the event. The OFIM processor 220 may then follow the corresponding error correction process by making calls or queries to necessary database(s) or other information source, for example, and update the event with the corrected information obtained therefrom. In some embodiments, the OFIM processor 220 may drop the event back to the retry queue with the error flag turned off, at which point the retry processor determines that it is a regular event (with the corrected information added) and forwards it on for resubmission to the external system.

FIG. 3a illustrates a chart 300 correlating sample error or rejection codes 302 with associated descriptions 206, adapters 304, available contact systems for resolution 308 and functionalities 310. As described above, an error or rejection code may be received by order and transaction processing engine 106 from any external system 114 that rejects a submitted order or request. In some embodiments, such error or rejection code may comprise an alphanumeric identifier, for example, that can be used by order and transaction processing engine 106 to identify the reason for the rejection. For example, supposing a order and transaction processing system 106 submits an order or request to an external system 114 and receives in response a code comprising of “ISP-005.” With this information, order and transaction processing engine 106 may then determine several bits of information that can help correct the cause of the error and resubmit the order or request to the external system for resolution and fulfillment. For instance, the sixth row from the bottom of chart 300 contains a code “ISP-005” in column 302, and associated with this code is a description in column 306 stating that the code relates to a missing UserId. In addition, chart 300 indicates that the missing UserId may be found by contacting the ISP Provision system, as reflected in column 308, and that the corresponding adapter for communicating with the ISP Provisioning system is the provisioning adapter, as indicated in column 304. Lastly, chart 300 describes the functionality or rules to be followed to correct the error, namely that the missing UserId can be retrieved from the ISP Provisioning system based on the service element ID or profile customer account number (“PCAN”), for example. The service element ID may comprise, for example, an internal system identifier that can map to a particular service for a certain customer. In some embodiments, each external system may have its own internal identifiers. Some of these internal identifiers may be used as cross references across multiple systems.

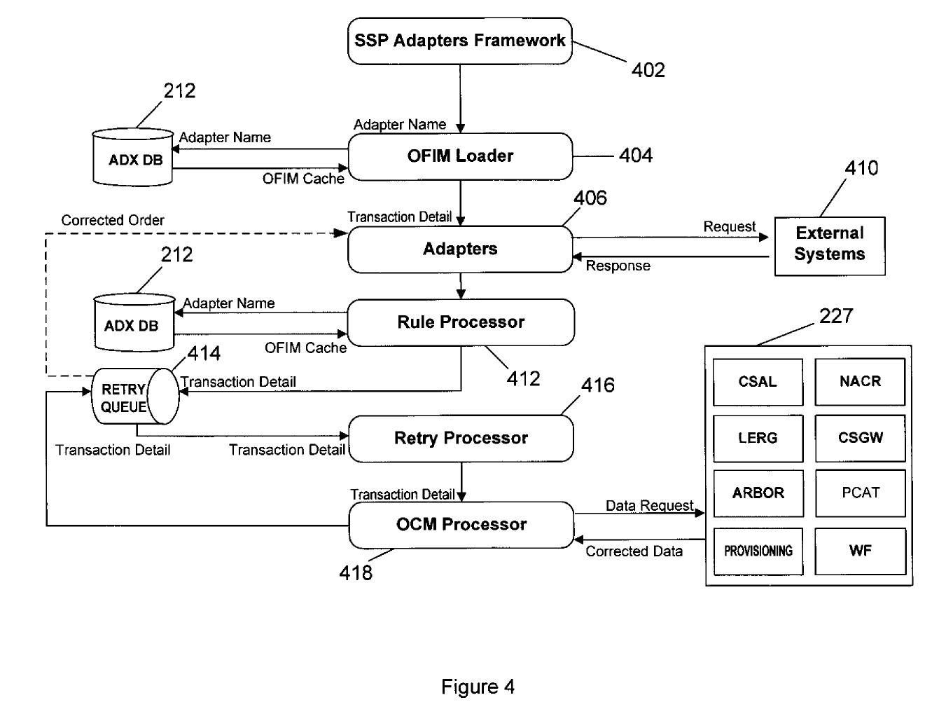

FIG. 4 is a flowchart illustrating the functionality of an order and transaction processing system 106 for processing orders and transactions of a particular embodiment. This exemplary method 400 may be provided by way of example, as there are a variety of ways to carry out the method. The method 400 shown in FIG. 4 can be executed or otherwise performed by one or a combination of various systems. The method 400 is described below may be carried out by the systems and networks shown in FIGS. 1, 2 and 3, by way of example, and various elements of the order and transaction processing system 106 and communication network 104 are referenced in explaining the example method of FIG. 4. Each block shown in FIG. 4 represents one or more processes, methods or subroutines carried out in exemplary method 400. Referring to FIG. 4, exemplary method 400 may begin at block 402.

At block 402, SSP adapters module 205 may receive a request from a user device 102(1-N). The request may originate from a customer or call center representative of service provider 112 and may relate to any transaction requiring processing and resolution. The request may be associated with various information that is needed for resolution. In some embodiments, SSP adapters module 205 may determine the name of a particular adapter that corresponds to and is able to communicate with the external system that will need to be invoked to process and resolve the request. In some embodiments, the name of the adapter may be known from preexisting rules and settings that associate transactions and the various external systems for processing and fulfilling transactions. Once the appropriate adapter is known, SSP adapters module 205 may then forward the request and name of the adapter to OFIM loader module 210.

At block 404, OFIM loader module 210 may take over the request and forward the adapter name to an adapters database 212. In so doing, the OFIM loader module 210 may load the necessary algorithms and data from the database that are specific to the adapter corresponding to the necessary external systems. The request may then be submitted to an OFIM cache for processing by the corresponding adapter and ultimate submission to the appropriate external system.

At block 406, the request is transmitted to the appropriate external system 114 via the corresponding adapter 213. Next, at block 410, the adapter 213 receives a response from the external system indicating successful processing and resolution of the request or a rejection indicating that an error or failure occurred. For example, an external system may return the request along with an indication that the request could not be processed because it contained inaccurate or was missing essential data. Such indications may be made, in some embodiments, using designated codes that inform service provider 112 of the precise error or fault.

At block 412, the rules processor 215 may be invoked. In exemplary embodiments, OFIM rule module 215 may take the adapter name and the code received from the external systems and identify all the various error codes, or OFIM codes, that are configured for the particular adapter. If the error code received from the external system matches one of the codes configured for the adapter, the rejected request will be marked for automatic error correct. If there is no match, the error may be sent into a fallout queue. In some embodiments, each fallout Queue may be investigated and worked manually. For example, a person may be assigned to that particular queue to investigate the fallout. The person may then send the appropriately scrubs for the order, and manually resubmit the order to be re-processed.

In some embodiments, this is accomplished by turning on an error flag in a transaction detail object associated with rejected request which is then placed in a retry queue as an event that will be processed by an OFIM retry processor 225.

At block 416, OFIM retry processor 225 may process rejected requests (or events) that are placed in the retry queue. In exemplary embodiments, the retry processor may check for the presence of an error flag in the event. If the flag is turned off, the event object will be handled as a regular retry event without error correct and will be resubmitted to the external system for processing, as shown by the dashed line labeled corrected order. However, if the flag is on, the event will be handled for error correction. The OFIM retry processor will then update the event as an OFIM event and invoke the OFIM processor from the OFIM cache based on the adapter name and delegates the OFIM event to the OFIM processor.

At block 418, upon taking over the OFIM event, OFIM processor 220 may, in exemplary embodiments, identify the error correction process based on the OFIM code associated with the event. The OFIM processor 220 may then update the event with the corrected information. In some embodiments, this may involve submitting a data request to a database 227, for example, that is able to provide the missing or correct information needed to correct the event. The identity of the database 227 may be determined based on information derived from the rejection code associated with the event which was originally received from the external system that rejected the original transaction submission at step 406. In some embodiments, the OFIM processor 220 may drop the event back to the retry queue with the error flag turned off, at which point the retry processor determines that it is a regular event (with the corrected information added) and forwards it on for resubmission to the external system.

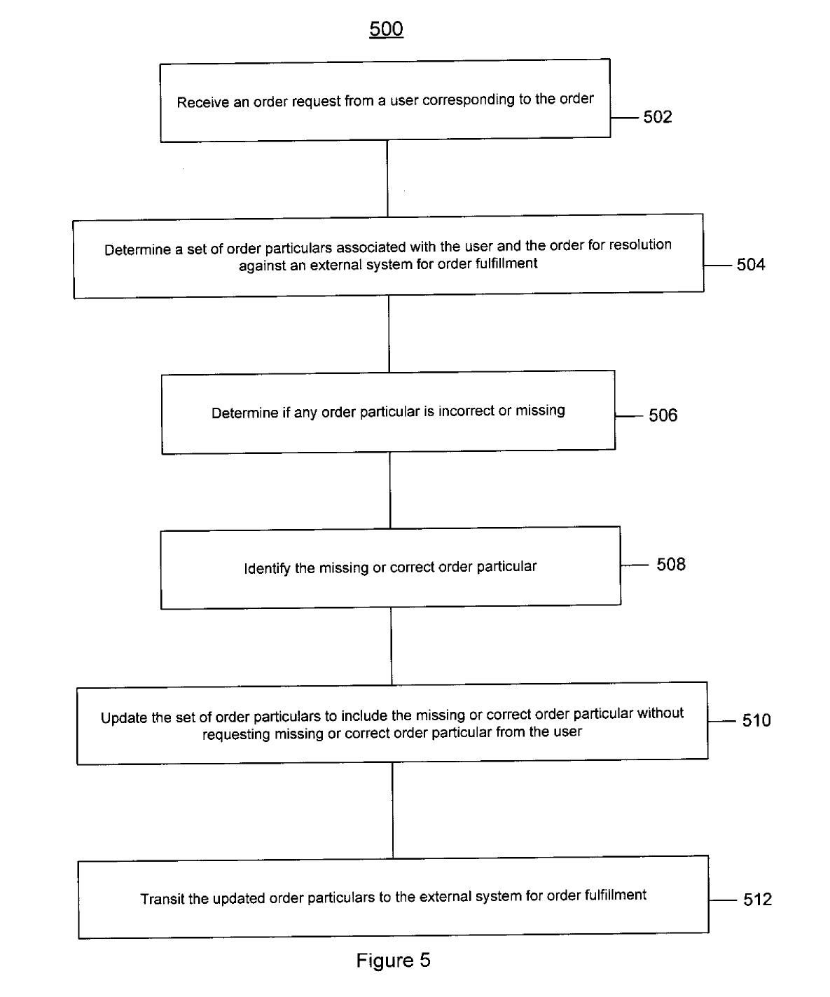

FIG. 5 is a flowchart illustrating the functionality of a network resource management agent 110 for determining whether to accept or deny a provisioning request of a particular embodiment. This exemplary method 500 may be provided by way of example, as there are a variety of ways to carry out the method. The method 500 shown in FIG. 5 can be executed or otherwise performed by one or a combination of various systems. The method 500 is described below may be carried out by the system and network shown in FIGS. 1 and 3, by way of example, and various elements of the network resource management agent 110 and communication network 104 are referenced in explaining the example method of FIG. 5. Each block shown in FIG. 5 represents one or more processes, methods or subroutines carried out in exemplary method 500. Referring to FIG. 5, exemplary method 500 may begin at block 502.

At block 502, the method 500 for determining whether to accept or deny provisioning requests may begin. In exemplary embodiments, an order request from a user corresponding to the order may be received via the order and transaction processing system 106 of FIG. 1. At block 504, a set of order particulars associated with the user and the order for resolution against an external system for order fulfillment is determined. For example, order particulars may be received from the customer or customer service agent initiating the order, or such particulars may be provided by the order and transaction processing system 106.

At block 506, a determination may be made as to whether any order particular is incorrect or missing. In some embodiments, missing or incorrect order particulars may be determined by an external system to which the order request was submitted for processing and resolution. The external system may indicate missing or incorrect data by providing a code or other indicator with the request and submitting it back to the order and transaction processing system 106 as a rejection of the request. At block 508, the missing or correct order particular may be identified. For example, upon receiving the rejection from an external system, the order and transaction processing system may note the presence of codes and use such code to identify the missing or correct data or information needed by the external system to process and resolve the request. Such data or information may be located via a look up table or database, for example.

At block 510, the set of order particulars may be updated to include the missing or correct order particular without requesting missing or correct order particular from the user. After the correct or missing data is identified, the order and transaction processing system 106 may update the request and queue it up for resubmission to the external system for processing and resolution. At block 512, the updated order particulars may be transmitted to the external system for order fulfillment.

In the preceding specification, various preferred embodiments have been described with references to the accompanying drawings. It will, however, be evident that various modifications and changes may be made thereto, and additional embodiments may be implemented, without departing from the broader scope of invention as set forth in the claims that follow. The specification and drawings are accordingly to be regarded in an illustrative rather than restrictive sense.

We claim:

1. A system comprising:
an order origination module for originating an order;
an order adapter module for transferring the order to the at least one external system for processing and fulfillment and for receiving from the at least one external system a fulfillment status of the order, wherein the order adapter module further comprises:
at least one adaptor configuration corresponding to the at least one external system, and
an order flow-through improvement module (OFIM) for correcting errors associated with a rejected order without interrupting an initiator of the order, wherein the error is identified by the OFIM based on a code or identifier added by the external system, and wherein the OFIM module further comprises an OFIM loader processor for identifying algorithms and data that are specific to the adapter corresponding to the necessary external systems.

2. The system of claim 1 wherein the order origination module originates the order in response to a user request.

3. The system of claim 1 wherein the fulfillment status indicates the status has been rejected because the order is missing data or contains incorrect data.

4. The system of claim 3 wherein the fulfillment status comprises an error code.

5. The system of claim 1 further comprising at least one external database for storing data to correct a rejected order.

6. The system of claim 1 wherein the OFIM module further comprises an OFIM loader processor for identifying algorithms and data that are specific to the adapter corresponding to the necessary external systems.

7. The system of claim 1 wherein the OFIM module further comprises a rule processor for identifying rules corresponding to a particular adapter.

8. The system of claim 1 wherein the OFIM module further comprises a retry processor for generating a queue of requests to be corrected.

9. A method, comprising:
receiving an order request from a user corresponding to the order;
determining a set of order particulars associated with the user and the order for resolution against an external system for order fulfillment;
determining if any order particular is incorrect or missing;
identifying the missing or correct order particular;
updating the set of order particulars to include the missing or correct order particular without requesting missing or correct order particular from the user; and
transmitting the updated order particulars to the external system for order fulfillment.

10. The method of claim 9 wherein the order request is received from the user via a mobile device, a terminal device, or a customer service station.

11. The method of claim 9 wherein the order particulars associated with the user comprises demographic information about the user.

12. The method of claim 9 wherein the step of determining if any order particular is incorrect or missing comprises receiving an error code from the external system.

13. The method of claim 9 wherein the step of identifying the missing or correct order particular comprises matching an error code from a list of error codes corresponding to an adapter.

14. The method of step 9 wherein the step of updating the set of order particulars to include the missing or correct order particular without requesting missing or correct order particular from the user comprises looking up the missing or correct order particular in a table or database.

15. The method of step 9 wherein the order is received by an order and transaction processing system.

16. The method of claim 9 wherein the order request is submitted by a customer of a service provider.

17. The method of claim 9 wherein the order request is submitted by a customer service agent of a service provider.

18. A non-transitory computer readable media comprising code which when executed causes a computer to perform the acts of the method of claim 1.

19. A system, comprising:
an external system for processing an event;
an order flow-through improvement module for correcting events, the order flow-trough improvement module comprising:
a loader module for determining appropriate rules corresponding to an adapter for communicating with at the external system;
a rule processor for generating a retry queue of events;
a retry processor for determining whether the event is a retry event or whether it should be resubmitted to the external system; and
a correction processor for correcting events in the retry queue of events.
